(19) United States
(12) Patent Application Publication
(10) Pub. No.: US 2014/0279404 A1
(43) Pub. Date: Sep. 18, 2014

(54) SYSTEMS AND METHODS FOR ASSUMABLE NOTE VALUATION AND INVESTMENT MANAGEMENT

(71) Applicants: James C. Kallimani, Austin, TX (US); Brett W. Young, Califon, NJ (US); Craig Lomicky, Clinton, NJ (US); Scott Celley, Clinton, NJ (US)

(72) Inventors: James C. Kallimani, Austin, TX (US); Brett W. Young, Califon, NJ (US); Craig Lomicky, Clinton, NJ (US); Scott Celley, Clinton, NJ (US)

(21) Appl. No.: 14/216,678

(22) Filed: Mar. 17, 2014

Related U.S. Application Data
(60) Provisional application No. 61/800,797, filed on Mar. 15, 2013.

(51) Int. Cl. G06Q 40/02

(52) U.S. Cl. CPC G06Q 40/025
USPC 705/38

(57) ABSTRACT

A system and method displaying information about an assumable note for a property's owner, an agent, a mortgage investor, mortgage servicer, mortgage sub servicer, or other stakeholder that is usable to refine an automatic current valuation and scoring of such note is described. The system obtains input from the property owner, mortgage investor, mortgage servicer, mortgage sub servicer, or other stakeholder adjusting at least one aspect of information about the note used in the automatic valuation and scoring of the note. The system then reports to the owner, agent, investor, servicer, sub servicer, or other stakeholder a refined current valuation and/or scoring of the note (the note's so-called, “Propensity to be Assumed”) that is based on the adjustment of the obtained input.

### CROSS-REFERENCE TO RELATED APPLICATIONS

The present application claims the benefit of U.S. Provisional Application No. 61/800,797, filed Mar. 15, 2013, entitled “Systems and Methods for Assumable Note Valuation and Investment Management”, which is hereby incorporated by reference in its entirety.

### BACKGROUND OF THE INVENTION

The present invention generally relates to computerized financial systems. More specifically, the present invention relates to computerized systems for interacting with assumable notes such as mortgages.

Assumable notes such as mortgages allow for the conveyance of the terms and balance of an existing mortgage to a new purchaser of a financed property, in lieu of having to obtain new financing, provided in most cases that the assumptor is qualified under lender, insurer or guarantor guidelines.

### BRIEF SUMMARY OF THE INVENTION

One or more of the embodiments of the present invention provide systems and methods for determining the present value of an assumable mortgage including an assumption value and a propensity for assumption. Several systems and methods are then provided to allow parties such as buyers, sellers, and investors to use the assumable mortgage valuation and/or propensity for assumption in transactions to purchase or sell the underlying real estate and/or the assumable mortgage note itself.

### BRIEF DESCRIPTION OF THE DRAWINGS

FIG. 1A illustrates an assumable note valuation and investment system according to an embodiment of the present invention.

FIG. 1B illustrates a homebuyer embodiment of the assumable note valuation and investment system of FIG. 1.

FIG. 1C illustrates a Mortgage Servicer Right (MSR) owner embodiment of the assumable note valuation and investment system of FIG. 1.

FIG. 1D illustrates a Mortgage Servicer Right (MSR) investor embodiment of the assumable note valuation and investment system of FIG. 1.

FIG. 1E illustrates a Mortgage Backed Security (MBS) investor embodiment of the assumable note valuation and investment system of FIG. 1.

FIG. 1F illustrates a Mortgage Sub Servicer embodiment of the assumable note valuation and investment system of FIG. 1.

FIG. 1G illustrates a Home Owner/Mortgager embodiment of the assumable note valuation and investment system of FIG. 1.

FIG. 1H illustrates an Owner of Non-Performing Mortgagor(s) embodiment of the assumable note valuation and investment system of FIG. 1.

FIG. 1I illustrates a Real Estate Agent embodiment of the assumable note valuation and investment system of FIG. 1.

FIG. 2 is a flow diagram showing steps typically performed by the system to automatically build the capability to determine valuations in a geographic area (or other constraints defined).

FIG. 3 illustrates a recent assumption opportunities table showing sample contents of recent assumption opportunities.

FIG. 4A illustrates a flowchart of a recursive function that constructs each node of the tree.

FIG. 4B is a continuation of FIG. 4A

FIG. 5 is a table diagram showing sample contents of a basis table containing the basis information selected for the tree.

FIG. 6 is a tree diagram showing a root node corresponding to the basis table 500.

FIG. 7 is a tree diagram showing a completed version of the sample tree.

FIG. 8 shows a flowchart of the steps typically performed by the system in order to score a tree.

FIG. 9 is a list of some of the attributes included in the system.

FIG. 10 is a flow diagram showing steps typically performed by the system when it is serving a user query or queries.

FIG. 11 is a flow diagram showing steps typically performed by the system when it is scoring the propensity of a note to be assumed.

FIG. 12 is a flow diagram showing steps typically performed by the system to automatically determine the Projected Buyer's Benefit, the Projected Seller's Benefit and the Projected Agent's Benefit.

FIG. 13 is a flow diagram showing steps typically performed by the system to automatically determine the Buyer's/Seller's maximum benefits.

FIG. 14 illustrates seller valuation system query interface.

FIG. 15 illustrates an alternative geographic property selection interface for selection of a property, as further described herein.

FIG. 16 illustrates the seller valuation system query interface when a successful address entry has led to the population of the interface with information about the assumable mortgage to be found at the property.

FIG. 17 illustrates the seller valuation system query interface when the seller modifies attributes in the interface.

FIG. 18 illustrates a configure links interface.

FIG. 19 illustrates a MSR valuation system interface.

FIG. 20 illustrates a modified MSR valuation system interface.

FIG. 21 is a flow diagram showing steps typically performed by the system to automatically determine a Mortgage Servicing Right (MSR) value.

FIG. 22 is a flow diagram showing steps typically performed by the system to automatically build the Loan Survival Model that will convert a Propensity Score into a loan survival factor.

FIG. 23 illustrates a property alerts interface.

FIG. 24 illustrates a mobile property alerts interface.

FIG. 25 illustrates a mobile alerts property distance interface.

FIG. 26 illustrates a mobile property alerts results interface.

FIG. 27 is a flow diagram showing steps typically performed in order to administer the system.

FIG. 28 is a flow diagram showing steps typically performed by the system to build a Buyer's/Seller's Valuation Model.

FIG. 29 is a flow diagram showing steps typically performed by the system in order to transform mortgage assumption data for future use.

### DETAILED DESCRIPTION OF THE INVENTION

Below is a glossary of standard terms that apply herein unless the terms are used otherwise or expanded upon below.

Amortization—The paying off of debt in regular installments over a period of time.

Arrears (mortgage in arrears)—Payments, which have become due on a note but not yet paid.

Assumable Mortgage—Assumable mortgages allow for the conveyance of the terms and balance of an existing mortgage to a new purchaser of a financed property, in lieu of having to obtain new financing, most often provided that the assumer is qualified under lender or guarantor guidelines

Assumptor—One who executes an agreement to assume and to pay an existing mortgage debt.

Basis Point—A unit that is equal to 1/100th of 1%, and is used to denote the change in a financial instrument. The basis point is commonly used for calculating changes or differences in interest rates.

Buyer's Ratio is the portion of the maximum buyer's benefit that the Buyer is estimated to receive if the mortgage is assumed as part of the sale.

Buyer/Seller Apportionment Function is the function that determines the proportional split (apportionment) to the seller and the buyer of their respective benefits.

Coefficient of credit availability (Credit Availability Coefficient) System generated scoring of the willingness of mortgage lenders to lend to real estate purchasers as well as an overall reading of general credit availability.

Constituency—the people involved in or served by an organization (as a business, governmental entity, or institution)

Convexity—A measure of the sensitivity of the duration of a bond to changes in interest rates, the second derivative of the price of the bond with respect to interest rates (duration is the first derivative). In general, the higher the convexity, the more sensitive the bond price is to the change in interest rates.

Credit Score—A statistically derived numeric expression of a person's creditworthiness that is used by lenders to access the likelihood that a person will repay his or her debts.

Department of Housing and Urban Development (HUD) is the principal Federal agency responsible for programs concerned with the Nation's housing needs, fair housing opportunities, and improvement and development of the Nation's communities.

Direct endorsement (DE) underwriter—an individual or entity that has direct endorsement certification from HUD—that is, one that can underwrite and approve loans that are insured by the Federal Housing Administration (“government” loans).

Distance Threshold is a distance value set by a user above which or below which alerts are generated and a certain action or actions will be taken.

Due-On-Sale Clause—A provision in a mortgage contract that requires that the mortgage be repaid in full upon a sale or conveyance of interest in the property that secures the mortgage. Mortgages with a due-on-sale clause are not assumable unless lender or mortgage owner agrees not to invoke the clause.

Duration. A measure of the sensitivity of the price of a fixed-income investment to a change in interest rates.—A measure of the sensitivity of the duration of a bond to changes in interest rates. Duration is the first derivative of the change. Duration can also expressed as the expected life that a fixed income investment such as a mortgage is likely to be outstanding in number of years.

Extension risk—The risk of a security's expected maturity lengthening in duration due to the deceleration of prepayments.

Federal Housing Administration (FHA)—a United States government agency created as part of the National Housing Act of 1934. It insures loans made by banks and other lenders for home building and home buying. The goals of this organization are to improve housing standards and conditions, provide an adequate home financing system through insurance of mortgage loans, and to stabilize the mortgage market.

Home Equity Line of Credit (HELOC)—A line of credit extended to a homeowner that uses the borrower's home as collateral. Usually a second mortgage. Investor (Mortgage Investor)—a lender, financial institution, Bank, thrift, Mortgage Real estate investment trust (REIT), or any individual or entity that owns a mortgage or mortgage security.

Loan Level Analysis—Analysis of a pool or portfolio of mortgages where analysis is conducted on each individual note within the portfolio as opposed to pool-level analysis. Loan level analysis is a more detailed approach.

Loan Level Pricing Adjustment (LLPA) are essentially charges for risk factors such as low credit scores, high loan-to-value (LTV), property type, etc.

Loan to Value (LTV) ratio—a ratio of the amount of a potential or existing loan to the asset it is intended to finance or is financing.

Mortgage Assumption Value (MAV) is the net present value, using the prevailing interest rate for the discount rate, of the interest savings over remaining life of assumable loan due to the assumable interest rate being lower than the prevailing interest rate.

Mortgage Servicer—An entity that acts on behalf of a trustee for security holders benefit in collecting funds from a borrower, advancing funds in the event of delinquencies and, in the event of default, taking a property through foreclosure. Term frequently used same as mortgage servicer but some nuanced differences may occur particularly if a mortgage or security involves guarantees

Mortgage Insurance—An insurance policy that protects a mortgage lender or title holder in the event that the borrower defaults on payments, dies, or is otherwise unable to meet the contractual obligations of the mortgage.

Mortgage Pool—A group of mortgage loans with generally similar characteristics that are combined to form mortgage-backed securities.

Mortgage Servicing Rights (MSR)—A contractual agreement where the right, or rights, to service an existing mortgage are sold by the original lender to another party who specializes in the various functions of servicing mortgages. Common rights included are the right to collect mortgage payments monthly, set aside taxes and insurance premiums in escrow, and forward interest and principal to the mortgage lender.

Multiple listing services (MLS) a marketing database set up by a group of cooperating real estate brokers. Its purpose is to provide accurate and structured data about properties for sale. It also is a mechanism for listing brokers to offer compensation to buyer brokers who bring a buyer for their listed property

Outstanding principal balance OPB (unpaid principal balance UPB) Principal balance of a loan remaining at a point in time

Prepayment speeds—the estimated rate at which mortgagors pay off their loans ahead of schedule, critical in assessing the value of mortgage pass-through securities.

Projected Buyer's Benefit is the projected, estimated, approximate dollar amount that a Buyer may save each month, each year, or over the life of the loan in the form of reduced interest payments due to the assumable mortgage loan being transferred from the seller to the buyer.

Projected Seller's Benefit is the projected, estimated, approximate dollar amount that a Seller may receive in the form of increased sale price of his or her home due to the assumable mortgage loan being transferred from the seller to the buyer.

Propensity Score is a derived measure of the propensity of an assumable mortgage loan to be transferred from the home seller(s) to the new home owner(s) when a property is sold. The measurement range is from 0 to 1000.

Propensity Scoring System (PSS) is the system that produces a Propensity Score for a given assumable mortgage note and context attributes.

Propensity Score Threshold is the value of the Propensity Score above which or below which alerts are generated and a certain action or actions will be taken.

Propensity to Assume (Propensity of Assumption)—Scoring terminology of described system. Predisposition, ranking, or scoring that a note or mortgage will be assumed.

Real Estate Agent—A person or entity that represents a buyer or a seller in a real estate transaction including a real estate broker, realtor, electronic or web based facilities designed to bring buyers and sellers together, listing and multiple listing services, and other entities or individuals involved in real estate transactions.

Second Mortgage (Secondary Financing)—A mortgage sec ed by a property lien that is subordinate to another mortgage on the same property.

Sellers Ratio is the portion of the maximum seller's benefit that the Seller is estimated to receive if the mortgage is assumed as part of the sale.

Servicer (mortgage servicer)—A business that mortgage issuers pay to administer their mortgages. The servicer typically accepts and records mortgage payments, manages escrows, handle workout negotiations if the homeowner defaults, and may supervise the foreclosure process if negotiations fail.

Short Sale—is a sale of real estate in which the proceeds from selling the property will fall short of the balance of debts secured by liens against the property, and the property owner cannot afford to repay the liens' full amounts, and whereby the lien holders agree to release their lien on the real estate and accept less than the amount owed on the debt.

Sub Servicer (Mortgage sub servicer)—an individual or entity retained by a servicer or owner of mortgage servicing rights of a mortgage or mortgage pool to administer the mortgages

User Valuation is the output of a valuation system which is a value or a set of values that is/are quantitatively descriptive of the assumable mortgage loan. The term User Valuation is used to represent a set of value parameters that is determined by the user type. For example, mortgagors would mostly be concerned with the Seller's Projected Value, but MSR investors would be more concerned by the MSR Value.

User Valuation Model is a set of routines that factors in the Propensity Score according to a specialized method to arrive at assumption value(s) for one type of user.

User Value Threshold is a value that is set by a user above which or below which alerts are generated and a certain action or actions will be taken.

Veterans Administration (VA) is a government-run military veteran benefit system with Cabinet level status. It is the United States government's second largest department

In many instances, it may be useful to be able to automatically and accurately determine the value of an assumable mortgage or “note” and to automatically and accurately determine the propensity of an assumable note to be assumed. By being able to accurately determine the value of an existing or outstanding assumable note, this allows for several comparisons, which may create or expose value to various stakeholders in transactions or assessments involving assumable notes. The value of an assumable note and the ability for various stakeholders in the note to be able to recognize or identify value is dependent on both objective and subjective inputs. Hence, a system that may quantify these inputs may add significant opportunity for facilitating and enhancing financial transactions and benefit real estate markets.

There are many examples wherein using objective and subjective inputs to determine accurate values for an existing assumable note based on current conditions. In a first example, home sellers whose property is financed with an assumable note might assess whether a sales premium might be sought or obtained from a buyer who might otherwise consider non-assumable note financing. In a second example, prospective home buyers may look for properties that specifically have been financed by the property's current owner through an assumable note with favorable characteristics such that they perceive and recognize value or savings by assuming the existing mortgage. In a third example, servicers of existing assumable mortgages might act to help ensure notes are assumed rather than paid off in a sales transaction so as to retain servicing rights. In a fourth example, investors in Mortgage Backed Securities (MBS) may have a considerable interest in a system enabling them to identify whole (individual) loans or groups of mortgages (mortgage pools) with a high likelihood of being assumed enabling them to properly hedge or adjust their MBS positions against potential extension risk or other risks. In a fifth example, a real estate agent may find it valuable to have a tool allowing them to identify properties offering value to the buyer and seller through the assumption process as well as being able to identify if the property had a high likelihood or propensity to be assumed.

In one embodiment, an investor in the note may consider factors such as terms and conditions of the note, the interest rate the note was written at, current market interests rates, market conditions, suitability, worthiness of the borrower, the expected lifetime or duration of the note (which for mortgages are typically less than the note's term), convexity, extension risk and various other factors. The investors computation is one that accentuates return and risk management. For these reasons, perception of a note's value is not necessarily aligned with that of a borrower.

Mortgage servicing rights (MSR) owners, mortgage servicers and sub servicers may consider yet another set of factors. For servicers, the longer a note is outstanding the greater the economic value recognized by the servicer as fees from servicing are stretched out over a longer period of time. In order to enhance or maximize value from an assumable note, it may be in the interest of the servicers and sub servicers to act in order to identify and/or increase the likelihood for a note to be assumed rather than a new note be executed by a buyer in a real estate transaction or transference where the servicer might not retain the new loan's servicing rights.

The stakeholders which may find value in the ability to value and score assumable mortgages or notes include, but are not limited to owners of homes financed with assumable notes, owners of homes not financed with assumable notes (for comparative purposes on sale), prospective buyers of homes, owners of mortgage servicing rights, mortgage servicers, mortgage sub servicers, mortgage investors, mortgage backed securities (MBS) investors, mortgage valuation service providers, realtors, real estate brokerage entities, multiple listing services (MLS), electronic or internet based real estate information websites, mortgage originators, Governmental agencies (some providing assumability as either a benefit or an entitlement such as Veterans Administration (VA) or Federal Housing Administration (FHA)), second mortgage/home equity line of credit (HELOC) lenders, Government Sponsored Enterprises (GSEs), title insurance providers and agents, direct endorsement (DE) underwriters, economic advisory entities, and other entities with interests in assumable mortgages.

If a system that automatically valued assumable notes based only upon the contents of a public database, and without input from each stakeholder's data or other information not in the public database had been constructed, such a system, would have failed to consider significant information and may result in valuations that are significantly inaccurate in many instances.

In one or more embodiments, the nature of assumable note valuation relies heavily on the context of the value stakeholder. Thus, a seller of a property financed with such a note and readily assumable by a buyer of the property might view it as added value within the transaction and request a home price premium. The buyer may relent to such a request seeing that current interest rate and credit availability is not as favorable as it was at the time the property owner executed the assumable note, for example. However, the value and ability to recognize value of the assumption feature of the note is subtler in other contexts.

For example, a mortgage servicing rights (MSR) owner, servicer or sub servicer desires primarily that the note be assumed so that the servicing right continues. Therefore, the MSR owner, the servicer or sub servicer may desire a system to “score” the note as being a more likely candidate (higher score) to convert (be assumed and continue) in a property transaction or a note with a lower propensity to be assumed given a lower score. Further to this example, let us discuss a home that had an assumable note originated with a loan-to-value (“LTV”) of 90% five years ago. After five years, the home has appreciated a bit and the note paid down nominally through amortization. Today, that note might represent an 80% LTV. Therefore, a servicer or sub servicer might assign a high score to this note given that it is a good candidate for a new buyer to be endorsed to assume this existing mortgage. Conversely, an assumable mortgage with a 50% LTV might offer little to the new buyer since the new buyer might need a second mortgage with an offsetting higher interest rate or payment due to the inability to support a 50% down payment. Therefore, a servicer or sub servicer may compare and score this note as having a low propensity to be assumed. However, a second-mortgage lender might see this latter case differently within their context, because a 50% down payment is beyond the resources of most buyers the situation represents a possible lending opportunity for the second-mortgage lender.

In the case of an owner or potential investor of a mortgage backed security (MBS) or an individual seeking to determine valuation risks and effects of mortgage assumability on the mortgages within a respective individually or within a mortgage pool, it may add significant value for analytical and valuation purposes for the MBS investor to incorporate both propensity of assumption for each distinguished loan in the pool as well as the estimated value of the assumption as it applies in determining a refined valuation, extension risk or other risks. Alternatively, a real estate agent may be maximizing their opportunity to complete a sale transaction by identifying both the embedded additional value offered by a listed property financed with an assumable mortgage with a higher likelihood or propensity to be assumed.

In view of the shortcomings of conventional approaches to valuing assumable notes discussed above, a new approach to valuing and comparing assumable notes that is responsive to input, both human and electronic, as well as having a high level of accuracy, being inexpensive and convenient, and tailored for the stakeholders of each assumable note, may have significant utility.

FIG. 1A illustrates an assumable note valuation and investment system 100 according to an embodiment of the present invention. The assumable note valuation and investment system 100 includes user systems 106, connected systems 130, interface systems 135, external data systems 140, user valuation systems 145, a propensity scoring system 114, an assumable mortgage database 115, a data transformation system 116, and user data 124. As further described below, the user systems may include a home buyer computer system 101, a home seller computer system 102, an agent or realtor computer system 103, a MRS investor computer system 104, and other computer systems 105. The connected systems 130 may include real estate search portal systems 107, mortgage management systems 108, and other systems and applications 109. The interface systems 135 include an interactive query system 110, an alerts system 111, an application program interface (API) 112 and an administrative system 113. The external data systems 140 include public record systems 117, third party data systems 118, and other data systems 119. The user valuation systems 145 include a buyer/seller valuation model 120, an agent/realtor valuation model 121, a MSR valuation model 122, and other valuation models 123.

FIG. 1B illustrates a homebuyer embodiment of the assumable note valuation and investment system of FIG. 1A. FIG. 1B is a diagram showing an example of how a potential home buyer would access an Internet or electronic based embodiment of the system. The user, the buyer, would input a desired location or locations and the system would respond with a list of properties that have assumable loans and assumption benefits that match user defined thresholds. The buyer might access the system interactively or by choosing specific properties they find on a real estate listing website. The system would also provide the user with the embedded (imputed)

Mortgage Assumption Value (MAV), the monthly interest/payment savings (MS), the life of loan savings (LOL) and display a presentation of propensity of assumption easily understandable by the buyer. The website using the system also allows for the buyer to input variables to understand how changes in (for example) interest rates would further influence potential value on sale of the assumable note.

FIG. 1C illustrates a Mortgage Servicer Right (MSR) owner embodiment of the assumable note valuation and investment system of FIG. 1A. FIG. 1C is a diagram showing how a mortgage servicer may use the system by inputting loan specific data and inputs of current market mortgage rates and home valuation estimates from third parties to determine a score, the propensity of assumption, for the distinguished home/note. The diagram shows how based on the system's scoring the servicer would pursue their effort to encourage assumption of the note/home should the owner decide to sell the property.

FIG. 1D illustrates a Mortgage Servicer Right (MSR) investor embodiment of the assumable note valuation and investment system of FIG. 1A. FIG. 1D is a diagram showing how an investor in mortgage servicing rights (MSRs) may utilize the system to identify the propensity of assumption of each loan in the MSR's underlying pool by determining how assumption would affect future servicing cash flows to the investor. The investor in MSRs could use this analysis to more accurately value an MSR and from that decide on whether to purchase or sell an MSR.

FIG. 1E illustrates a Mortgage Backed Security (MBS) investor embodiment of the assumable note valuation and investment system of FIG. 1A. FIG. 1E is a diagram showing how a mortgage backed securities (MBS) investor or MBS modeler (pricing modeler) may utilize the system by supplying comprehensive loan-level data for each underlying note in the MBS pool. The user may also provide additional hypothetical inputs including interest rate scenarios and credit market scenarios. The system would provide the MBS Investor/MBS modeler with values of both embedded assumption value (if any) for each note and would additionally provide the user with the propensity of assumption for each note. The system would also calculate these outputs under the variable scenarios for which the user provided parameters. The user would employ the outputs to determine cash flow, default, and prepayment analysis which any recognized variance would affect both the duration and convexity of the MBS security. Duration and convexity are two of the most primary valuation tools in MBS valuation.

FIG. 1F illustrates a Mortgage Sub Servicer embodiment of the assumable note valuation and investment system of FIG. 1A. FIG. 1F is a diagram that shows how a sub servicer may use the system. By dynamically and frequently applying refreshed loan level updates of embedded assumption values and propensity of assumption the sub servicer will have identified note/home candidates with a strong assumption proposition to a buyer of the home. Further, the sub servicer using the system also inputs on a frequent (daily) basis input from a multiple listing service (MLS) of all new home listings within a certain period (24 hour minimum). New listings with high propensity of assumption and significant embedded assumption value represent an ideal and timely opportunity for the sub servicer and/or MSR to immediately contact the mortgagor/seller and educate them on the opportunity. On assumption, the seller may receive a higher value for their home on sale and the house may sell quicker. The MSR owner and sub servicer create value for themselves as servicing revenues continue into the future.

FIG. 1G illustrates a Home Owner/Mortgager embodiment of the assumable note valuation and investment system of FIG. 1A. FIG. 1G is a diagram showing an example of how a homeowner with a mortgage would access an Internet or electronic based embodiment of the system. The user, the homeowner, would input data specifically about their note and property and in conjunction with other available data that the system would access, the system would determine if the terms of the note make it technically assumable. The system would also provide the user with the embedded (imputed) assumption value, and display a refined presentation of propensity of assumption easily understandable by the homeowner. The website using the system also allows for the homeowner/mortgagor to input variables to understand how changes in (for example) interest rates would further influence potential value on sale of the assumable note.

FIG. 1H illustrates an Owner of Non-Performing Mortgagor(s) embodiment of the assumable note valuation and investment system of FIG. 1A. FIG. 1H is a diagram of how an owner/investor of a non-performing mortgage, regardless of whether the note is traditionally assumable, may use the system. Under many circumstances a note owner can choose to not enforce or invoke a note's due-on-sale clause in a sale transaction, allowing assumption of the note/property. The system, in this application, provides a tool for the user to recover and/or protect value in a loan that may be non-performing or poorly performing.

FIG. 1I illustrates a Real Estate Agent embodiment of the assumable note valuation and investment system of FIG. 1A. FIG. 1I is a diagram of how Real Estate Agent may use the system. The user, the real estate agent, would input a desired location or locations and the system would respond with a list of properties that have assumable loans and assumption benefits that match user defined thresholds. Homes that have larger assumption values and higher assumption propensities are more likely to sell, sell faster, and or sell at a higher price.

Overview

Systems and methods for automatically valuing and scoring an assumable note (mortgage) that is tailored to input from a property buyer/seller, agent, mortgage investor, mortgage servicer or other existing note stakeholder (“the system”) are described. While the following discussion liberally employs the word “note” to refer to an assumable mortgage being valued, those skilled in the art will appreciate that the systems and methods may be straightforwardly applied to notes of other types. Similarly, while a number of users and uses are described herein, including use by a prospective property buyer or seller, use by an agent or other person representing a buyer or seller, use by a note holder, use by a note investor, or use by a servicer/sub servicer, those skilled in the art will appreciate that there are many other potential users and uses for the systems and methods.

In some embodiments, the system uses a web site to receive information from a user and display or report to the same or another user(s) a refined valuation or scoring of the assumable note. In some embodiments, the information provided by the user may include additional, corrected, and/or updated attributes of the assumable note relative to the attributes known by the system, such as attributes retrieved by the system from a public or private database of assumable notes; information about changes to the assumable notes; information about other factors likely to affect the value of the assumable notes, such as (prevailing) interest rates, changes in borrower worthiness, geographic density of other assumable notes, willingness of Mortgage Servicing Rights (“MSR”) holder or other stakeholder to facilitate an assumption, etc. In some embodiments, the system displays or reports the results of refining its valuation in a manner that makes clear how the valuation was affected by the different information inputs (both user inputs and public/private data update inputs).

By enabling a user to refine a valuation and/or scoring of assumable notes based upon information about the assumable note(s) known to the user, the system in many cases makes the valuation and/or scoring more accurate than might otherwise be possible, and/or helps the user to more fully accept the valuation as appropriate.

Assumable Loan Valuation and Scoring

In some embodiments, the system constructs and/or applies financial models each constituting a forest of classification trees. In some embodiments, the system uses a data table that identifies, for each assumable note existing in a selection set (for example, geographic region) to which the forest corresponds, attributes of the assumable note. For each of the trees comprising the forest, the system randomly selects a fraction of notes identified in the table, as well as a fraction of the attributes identified in the table. The system uses the selected attributes of the selected notes and constructs a classification tree in which each non-leaf node represents a basis for differentiating selected notes based upon one of the selected attributes. For example, where the remaining term of a note is a selected attribute, a non-leaf node may represent the test “number of months remaining <=240”. This node defines 2 sub trees in the tree: one representing the selected notes having 240 and fewer months, the other representing the notes having 241 or more months remaining. Each leaf node of the tree represents all of the attribute values corresponding to the path from the tree's root node to the leaf node. The system assigns each leaf node a Propensity Score, which is a measure of the likelihood of the note to be assumed given a particular permeation of note attributes submitted to the system.

In some instances or geographies, loan assumption details might not be public record, and may be difficult or impossible to obtain. Accordingly, in some embodiments, the system estimates the attributes surrounding an assumable note in such a circumstance based upon, for example, the difference between the loan(s) valuation (s) and the associated home sale price.

In order to weight the trees of the forest, the system may further refine the scoring and, therefore, the usefulness of each tree by applying the tree to notes in the table other than the notes that were selected to construct the tree. By doing this, the scoring trees may be refined and therefore, the predictive accuracy improved based on empirical data. Another approach is employing accumulating registers within each leaf node that 1) accumulate notes actually assumed, and 2) tally the total candidate notes. Dividing the notes recently assumed by the number of candidates may, for example, produce a Propensity Score that is refined over the initial value, which may have previously been randomly selected.

In most cases, it is possible to determine the attributes of a note to be valued. For example, they may often be obtained from mortgage servicers, or note holder/investors. Alternatively, a person familiar with them, such as the borrower, a mortgage agent/broker, or a person that derives the information from the borrower or agent/broker may input a note's attributes. In order to determine a valuation and/or scoring for a note whose attributes are known, the system applies one or more trees to the note, so that each tree indicates a value/score for the note. The system then calculates an average of these values, each weighted by the score for its tree (leaf node), to obtain a value for the note. In various embodiments, the system presents this value to the borrower of the note, a prospective assumptor of the note, an agent/broker, a mortgage servicing rights representative, an investor, a direct endorsement underwriter or other compliance officer, a title agent, a mortgage insurer, or another person interested in the value or propensity of the note to be assumed or the valuation of a group of notes or propensity of the notes to be assumed that includes the distinguished note.

In some embodiments, the system applies its model to the attributes of a large percentage of notes in a geographic area to obtain and convey an average scoring for notes in that area. In the case of a mortgage servicing rights entity, the geographic region may be the entire United States encompassing all of the notes in their servicing portfolio. In some embodiments, the system periodically (based on time or changes in variables such as interest rates, credit conditions, etc.) determines an average valuation for notes in a selected set, and uses them as a basis for determining and conveying an index for such selected set.

Because the approach employed by the system to determine valuations and/or scoring of notes does not rely on the note having been recently assumed, it may be used to accurately value/score virtually any note whose attributes are known or might be determined. Further, because this approach does not require the services of a financial professional, it may determine a note's valuation quickly and inexpensively, in a manner generally free from subjective bias.

FIG. 1 is a block diagram showing some of the components on which the systems and methods typically execute. Potential user systems that interact with the system are shown in components 101-105. These user systems can interact with the system through the interactive query system 110 or through an external application system 107-109 such as a real estate search portal 107. External applications systems communicate with the system through its Application Program Interface (API) 112. User systems can also access the Alert System 111 to set up or customize alerts concerning assumable mortgage variances, changes in Propensity Score, or changes to user defined value.

Some users may be granted administrative privileges that allow them to access and operate the Administration System 113. The Administration system is used for building and storing various models including but not limited to the Propensity Scoring System 114. The Administration system is also used to perform or schedule maintenance activities and other administrative actions.

The system receives data from multiple external sources 117-119. Data includes but is not limited to public records 117 such as tax and lien information, third party data 118 such as MLS listings, loan data, and other data 119 such as relevant credit conditions. One important type of data is assumption opportunities, which are real estate sales transactions in which the seller possessed an assumable mortgage whether or not the loan was eventually assumed. Data processed by the system is stored in the Assumable Mortgage Database 115 preferably after it passes through the Data Transformation System 116. This is to ensure that the stored data is readably usable by the various models and components that are deployed throughout the system.

At the heart of the system is the Propensity Scoring System (PSS) 114. The PSS takes mortgage details including subjective and objective inputs from a variety of sources and returns the note's Propensity Score, which is a measure of the likelihood of the note to be assumed given a particular combination of note attributes submitted to the PSS.

The system has multiple User Valuation Systems 120-123. User Valuation Systems include user templates customized to a type of user as well as a set of procedures that determine value according to the particular perspective that type of user has on assumable mortgages. Each User Valuation System factors in the Propensity Score according to a specialized method to arrive at assumption value for that type of user. In some embodiments user models are created through the Administration System and stored in the Assumable Mortgage Database. Those skilled in the art would recognize that there are many different models that can be accommodated by the system, including models developed by and for third parties. For example a proprietary MBS analysis system can be incorporated into the system and utilize Propensity Score to create a refined view of extension risk and therefore a more accurate assessment of the overall value of a security.

In various embodiments, the system may be accessed by any suitable user interface including web services calls to suitable APIs. While components configured as described above are typically used to support the operation of the system, one of ordinary skill in the art will appreciate that this system and methods associated with this system may be implemented using devices of various types and configurations, and having various components.

In the following figures labeled 1B-1H, the users and the systems may be architected with any of the topologies discussed in FIG. 1A. A typical implementation may communicate bi-directional data with a user's own data and data provided by market data and other third-party providers including public databases, private databases, mortgage originators, mortgage servicers, title insurance companies, mortgage insurance companies, real estate brokers, real estate agents, Internet brokers, marketing companies, financial services companies, financial services data providers, market centers (exchanges for listed securities, commodities, futures, etc.) and individual users of the system.

FIG. 1B. In some embodiments the system may be accessed by or be a component of a real estate information or listing website that displays homes or properties that are for sale or potentially for sale to provide information to a user that is a potential home buyer. In addition to common features typically highlighted on real estate information and listing websites such as location (address), bedrooms, school district, square footage, pictures of home/property, improvements, etc., the website utilizes the system for purposes of identifying, evaluating and valuing the “financial” feature of assumability and to determine what value, if any, is present in the property's mortgage via assumption. The system accesses proprietary and third party databases containing objective and subjective data including but not limited to property specific loan level data of a distinguished property, current market interest rates, demographic information specific to the property's area, credit conditions, and demand trends pertinent to the specific neighborhood the home is located in. The system then identifies, scores and values the feature of assumability on the distinguished home and may determine how much, if any, a buyer of the mortgaged property may save by assuming the mortgage on the property in a transaction in lieu of obtaining new market rate financing. These savings values may include savings on a monthly, yearly, or life-of-loan basis and may be displayed as net present value or without adjustment for time value of money. The website would then publish the numbers provided by the system, either singularly or in addition to other home value estimates, for buyers to consider while making home purchase decisions.

FIG. 1C. In some embodiments, the user, a mortgage servicer may input attributes of the loan including loan type by guarantor or insurer, the outstanding principal balance, and the interest rate on the note. Using other inputs such as property value from the systems database, and current (today's) interest rates available on specified mortgage alternatives provided by third party pricing or quotation services. The system would provide an output and report to the servicer all loans with a Propensity Score above a threshold and a corresponding value that the servicer could report to the mortgagor as a potential premium the home might bring in a sale due to the assumable mortgage. The servicer benefits when the note is assumed. The higher the Propensity Score, the greater the marketing efforts the servicer will invest to retain the servicing.

FIG. 1D. In some embodiments, an investor in financial instruments such as a mortgage servicing rights (MSRs) investor may input into the system specific loan level inputs of mortgages or mortgage pools whose underlying MSRs are for sale at a specified price or open to bid and whose purchase the investor is contemplating. Servicing rights that are assumed represent an immediate and substantial financial benefit to the MSR owner because on assumption the servicing rights and hence cash flows are extended. A system that may identify loans with a high Propensity Score provides MSR investors a tool to better identify mispriced mortgages and mortgage pools and offers a tool to enhance profits and financial returns of the MSR investor.

FIG. 1E. In some embodiments an investor in one or more pools of mortgages might input loan level note data into the system in order to identify both the amount of imputed value in each below market assumable note and the Propensity Score under hypothetical interest rate scenarios, in addition to current market mortgage rates. This is important to an MBS investor, because in analyzing or modeling MBS portfolios, assumptions of mortgages within the portfolio or pool of mortgages can greatly affect the value of the security as the change in prepayment speeds of mortgages represents extension risk to the investor and may create a situation where a security should either be sold or hedged due to changes in duration and/or convexity of the portfolio.

FIG. 1F. In some embodiments, a sub servicer may use the system to dynamically and at recurring regular intervals (daily) compare inputs from distinguished loans/properties that the system has identified as individually possessing a substantial potential economic value in the assumption of the distinguished loan/property and/or has scored the propensity of assumption of the loan as high. The data supplied by the owner of the mortgage servicing rights (MSRs) can be compared daily against all new real estate listings garnered from multiple listing services (MLSs), electronic or internet based real estate brokerage and information sites, and/or third party providers of data of newly listed homes. It would be of great benefit to both the sub servicer and the owner of the MSRs to directly and immediately contact the home seller and communicate the identified additional potential value the listed home possesses as a function of its assumable mortgage. Significant value may be created by the system as 1) the mortgagor may receive a higher sale price for his home and the home may sell faster and 2) The home buyer may save financing costs as the assumed mortgage carries an interest rate lower than available market rates at the time of home purchase and although he is qualified as an assumptor constrained credit in the housing market may make assumption less costly and time consuming than taking out a new mortgage. Additionally, 3) the sub servicer has created value for both themselves and 4) the MSR owner (who they are contracted by) as servicing and sub servicing fees continue to be received if the mortgage is not paid off.

FIG. 1G. In some embodiments a user who is the mortgagor on a property and/or who is the owner of the property, whether or not the property is currently for sale, may access the system via an electronic terminal or through the Internet and input loan level specific data about the note and property. The system might provide the user with output as to whether 1) the property is assumable given certain terms and conditions of the note, 2) How much additional value (if any) the home with the assumable note (if assumable) might command if sold under current conditions. 3) What additional value (if any) the home with the assumable note (if assumable) might command if sold under various hypothetical inputs (time, market interest rates, credit conditions, etc.) and 4) how likely his home is to be assumed, for example. its Propensity Score, under current and hypothetical conditions.

FIG. 1H. In some embodiments the user of the system may be an owner of a note that is not assumable on its face or investor or a sub servicer representing the interests of such a note owner where the mortgage is in arrears, approaching foreclosure, has an excessive loan-to-value ratio, and/or may be a candidate for a short sale. In most cases, a note owner can choose not to invoke or enforce the due-on-sale clause contained within the mortgage note and/or deed documentation at the owners option, essentially deeming the note/property assumable. Thus, even though the note may not have been written as assumable, the lender of the non-performing notes (in conjunction with a borrower seeking to get out of the mortgage/property) may see an opportunity to replace a non-performing mortgagor with another borrower. If the mortgage rate on the assumable mortgage is significantly below current market rates and/or credit conditions are currently constrained in the lending market, by choosing to not invoke or enforce the due-on-sale clause the lender has the potential to create value in the property and at the same time avoid costly foreclosure or workout expenses in some cases. The owner of the non-performing notes or their representative may seek to identify situations, utilizing the system, whereby allowing a note/property to be assumed can offset, to certain degrees, losses being created by non-performance of the mortgage.

FIG. 1I. In some embodiments, a real estate agent, observant that interest rates have risen significantly, may seek to input into the system general location inputs such as a town or a zip code where the agent conducts business. The agent, seeking property sellers whom the agent believes are close to making a decision to sell and a sound ability to estimate local home value may seek the system output to identify homeowners/mortgagors with significant embedded additional value from the assumable feature and/or assumable notes/homes that the system scores as having a high propensity for assumption. The system, utilizing inputs of current interest rates provided manually by the user or through a quotation service in conjunction with loan level data in the system to score and identify homes currently financed with below current market rate assumable loans that are not yet for sale as confirmed through input from the local Multiple listing service (MLS) of which the realtor/agent is a member. The identification of additional value in the home through the existence of an assumable mortgage would represent a valuable sales tool for the real estate agent to approach a homeowner. Agents will seek properties with highest Propensity Score as they are more likely to sell, sell faster and sell at a higher price. All of which are extremely important to realtors both financially and in time commitment.

In some embodiments, a real estate agent representing a prospective home purchaser, observant that interest rates have risen significantly and/or that credit availability even for qualified borrowers is constrained, may seek to input into the system general location inputs such as a town or a zip code where the agent's client is seeking to purchase a home. The agent may utilize the system output to identify listed properties that have assumable notes currently financing the property. The system can also identify homes with assumable mortgages financed at below current market rates. These homes represent a value opportunity for the buyer that the agent represents.

FIG. 2 is a flow diagram showing steps typically performed by the system to automatically build the capability to determine valuations in a geographic area (or other constraints defined). Additionally, FIG. 2 is a flow diagram showing steps typically performed by the systems and methods to create the ability to automatically determine current scoring for assumable notes from a selection set. In the embodiment shown in the figure, the capability to score is created by construction a forest of trees. The system may perform these steps for one or more geographic areas of one or more different granularities, including neighborhood, city, county, state, country, etc. When mortgage servicing rights entities use the system, it is anticipated that such searches may be large geographic regions such as their entire domestic inventory of assumable notes. These steps may be performed periodically for each geographic area, such as daily. These steps may be performed automatically due to changes in the environment; if interest rates change, or if credit conditions or rules of assumption change, as examples.

First, at step 201, the number of desired trees for the forest is determined and entered into the system. As discussed below, the system may initially employ 100 trees, but a greater number may be selected to provide a more accurate model. Next, in step 202, the system selects recent assumption opportunities occurring in the geographic area or using some other constraint on the data. The system may use assumption data obtained from a variety of public or private sources. Next, at step 203, the system selects note and context attributes within the constraints given, wherein the constraint may be a selected geographical area. As further discussed herein, the constraint may be a particular geographic area such as a city, for example, and the system may identify all assumption opportunities that have taken place in the city during a preselected time. Further, for those assumption opportunities, the system may retrieve the details of the assumable mortgages that may or may not have been assumed. Next, at step 204, tree x is constructed, as further described below. Then at step 205, tree x is scored by determining its discernment factor as further described below. At step 206, the flowchart 200 proceeds to the next x.

Once all x trees have been constructed, the flowchart 200 proceeds to step 207 and each tree is weighted by dividing the score of each tree by the sum of the scores for all trees. Then, at step 208, the forest of trees is stored in the Propensity Scoring System in the assumable mortgage database, as shown in FIG. 1 above.

FIG. 3 illustrates a recent assumption opportunities table 300 showing sample contents of recent assumption opportunities. Assumption opportunities are completed sales in which the seller possessed an assumable mortgage whether or not the mortgage was actually assumed.

The recent assumption opportunities table 300 is made up of rows 301-314, each representing a home sale where an assumable mortgage was involved, whether or not the mortgage was eventually assumed. Each row is divided into the following columns: an identifier column 321 containing an identifier for the sale; a street address column 322 containing the street address of the property; a city column 323 indicating the city of the property; a state column 324 indicating the state of the property; an origination date column 325 indicating the date when the note was originated; an origination interest rate column 326 indicating the interest rate of the note when originated; an unpaid principal balance field 327 indicating the unpaid principal balance of the loan at the time of sale; a total sale price field 328 representing the price that the home was sold for; a Loan-To-Value (LTV) at sale column 329 indicating the ratio or loan to property selling price of the assumed note; a type column 330 indicating the type (FHA, VA, or USDA) of note originated; a mortgage assumed field 331 indicating whether or not the note was assumed when the home was sold; a date of sale field 332; a note servicer column 333 showing the servicer of the note for which assumption was an option.

For example, row 301 indicates that an assumption opportunity number 1 of the home at 5 Pine St., Teaneck, N.J. having an unpaid balance of $116,213, interest rate of 7.20%, originated on Mar. 1, 2003, was a VA note originated by Wells Fargo. While the contents of recent assumption opportunities in table 300 were included to pose a comprehensible example, those skilled in the art will appreciate that the system may use a sales table having columns corresponding to different and/or a larger number of attributes, as well as a larger number of rows. Attributes that may be used include but are not limited to those listed in FIG. 9. Other additional values may include a coefficient calculated to reflect the scarcity of assumable notes in an area (for example, areas close to a military base), a coefficient calculated to reflect the current credit conditions for either/both of originating new notes or/and assuming existing assumable notes. Coefficients and derived data may be useful attributes. A derived scarcity coefficient may be calculated by recording the number of notes assumed within a region and dividing that value by the total number of notes that were candidates for assumption during that same time frame. A derived credit conditions coefficient may be calculated by using the number of home financing applications approved divided by the total number of applications submitted. Another embodiment may use a related derived value calculated by taking the total number of assumed mortgages successfully underwritten divided by the total number of assumed mortgages submitted for underwriting. For a variety of reasons, certain values may be omitted from the recent sales or assumption opportunities table. In some embodiments, the system imputes missing values using the median value in the same column for continuous variables, or the mode (most frequent) value for categorical values.

While FIG. 3 and each of the table diagrams discussed below show a table whose contents and organization are designed to make them more comprehensible by a human reader, those skilled in the art will appreciate that actual data structures used by the system to store this information may differ from the table shown, in that they, for example, may be organized in a different manner, may contain more or less information than shown; may be compressed and/or encrypted; may be locally available to the computing devices or remotely (networked) available to the computing devices; etc. Though the data structures for the definitions of mortgages, attributes, their relationships, and scoring of propensity are tables and trees (forest with multiple trees), those skilled in the art of computing technology will appreciate that actual data structures and data types may include or be substituted with arrays, flat-file data structures, databases, relational databases, hash tables, graphs, maps, name-value pairs, tagged unions (variants), abstract data types such as Sets, enumerated types, Booleans, objects (data and program fragments), linked lists, doubly linked lists, stacks, queues, deques, bitmaps, buffers, circular buffers, hashed array trees, lookup tables, matrices, trees, binary trees, B-trees, heaps, multiway trees, space-partitioning trees, routing tables, and symbol tables, as examples.

Returning to FIG. 2 in steps 201-206, the system constructs and scores a number of trees, such as 100. This number is configurable, with larger numbers typically yielding better results but requiring the application of greater computing resources. In step 204, the system constructs a tree. Step 204 is discussed in greater detail below in connection with FIG. 4. In step 205, the system scores the tree constructed in step 204. Step 205 is discussed in greater detail below in connection with FIG. 8.

In FIG. 11 steps 1102-1103, the system uses the forest of trees constructed and scored in steps 201-207 to process requests for note valuations. Such requests may be individually issued by users, or issued by a program, such as a program that automatically requests valuations for all homes in the geographic area at a standard frequency, such as daily, or a program that requests valuations for all of the notes occurring on a particular map in response to a request from a user to retrieve the map. Other requests may be issued by users who have interest in portfolios of notes such as a mortgage insurance, provider, hedge fund investor, mortgage servicing rights holder, a sub-servicing rights holder, a secondary lending provider, or an individual or entity interested in investment management.

FIG. 11 is a flow diagram 1100 showing steps typically performed by the system when it is scoring the propensity of a note to be assumed. In step 1101, the system receives a request for valuation identifying the note to be valued. In step 1102 the system activates the Propensity Scoring System (PSS) built in FIG. 2 and stored in the Assumable Mortgage Database. In step 1103, the system compares the trees constructed in step 204, weighted in step 207 by the scores generated for them in step 205 to the attributes in the note identified in the received request in order to obtain a valuation for the note identified in the request. After step 1103, the system exits FIG. 11.

Those skilled in the art will appreciate that the steps shown in FIG. 2, and FIG. 11 and in each of the flow diagrams discussed below may be altered in a variety of ways. For example, the order of the steps may be rearranged; sub-steps may be performed in parallel; shown steps may be omitted, or other steps may be included; etc.

FIG. 4 is a flow diagram showing steps typically performed by the system in order to construct a tree. Prior to constructing a tree, in step 202 the system randomly selects a fraction of the recent assumption opportunities in the geographic area (or other basis) to which the tree corresponds, as well as in step 203 a fraction of the available attributes, as a basis for the tree. A detailed example for constructing a tree appears below with a more thorough explanation of FIG. 4.

FIG. 5 is a table diagram 500 showing sample contents of a basis table containing the basis information selected for the tree. Basis table 500 contains rows randomly selected from the recent assumption opportunities table 300, here rows 501, 502, 503, 504, 505, and 506. The basis table further includes the identifier column 521, street address column 522, city column 523, state column 524, remaining term column 525, LTV column 526, type column 527, and Propensity Contribution column 528 derived from the recent assumption opportunities table. Values in the remaining term column 525 are derived by calculating the number of months between the origination date column 325 and the current date and subtracting that number from 360. Values in the Propensity Contribution field 528 are calculated by taking the value “0” for each “n” in column 331 in FIG. 3 where the mortgage was not assumed and the value “1000” for each “y” where the mortgage was assumed. In alternative embodiments, the system selects various fractions of the rows and attribute columns of the recent sales table for inclusion in the basis table.

With regard to determining the Propensity Score for a mortgage (note) on a single residence, one exemplary method of doing so is as follows. First, a set of variables is determined. In this simplified example, we include the following variables (although any of the variables mentioned above may be used): original purchase price, outstanding principal balance, estimated home value, and current interest rate. Each of these variables may be quantized as convenient to form discrete groupings within the variable. For example, the interest rate variable may be quantized on a 0.25 point resolution so that all mortgages with interest rates between 4.25% and 4.50% are considered to be in a single grouping. As is readily appreciated, the number of groupings may vary. In one example, the interest rate variable includes 40 groupings based on 0.25 increments from 0% to 10%. Similarly, in one example, the outstanding principal balance variable may include groupings at a resolution of $25,000 and thus include 40 groupings from zero to $1,000,000.

Each specific variable combination then forms a unique category. For example, one category in the current example may be houses with an interest rate between 3.25% and 3.5% (interest rate grouping), an outstanding principal balance between $200,000-$225,000 (outstanding principal grouping), and original purchase price between $275,000 and $300,000 (original purchase price grouping), and estimated home value between $250,00 and $275,000 (estimated home value grouping). A different unique category would include all of the same values above except for estimated home value being between $275,000 and $300,000.

Each unique category forms a leaf of the tree discussed above. The process then proceeds to determine a Propensity Score for each leaf by “training up” the tree using past sales data. For example, the leaves of the tree may be initialized with an average Propensity Contribution. The initial Propensity Score may be the same for each leaf or may be tweaked to more closely reflect or model the expected variance in Propensity Scores across the distribution of categories. For example, loans having lower interest rates are more likely to be assumed, so in the interest rate variable the categories may be initialized with values that have a variance (such as a linear or parabolic variance) such that the categories having lower interest rates are initialized with a higher value.

Once the unique categories are initialized, historical housing sales data is then applied. More specifically, each sale in the historical housing data is placed into one of the unique categories. Because there are typically a large number of home sales in the distribution, typically each category becomes “filled” with a considerable number of home sales representing actual historical data. The actual assumption data for houses (holding assumable notes) occupying the category is then determined and used to adjust the Propensity Score for houses that might fall into that unique category.

In one example, the Propensity Contributions may be averaged with two or more epochs of historical data to form a new Propensity Score. Alternatively, a historically determined Propensity Contribution may instead be applied for the unique category. In an additional example, other iterative techniques such as successive over-relaxation or second-order models may be employed to converge the Propensity Score predictions quickly into an increasing accurate prediction of Propensity Scores.

Thus, once each unique category has become associated with a specific Propensity Score based on the training of the tree, a new (property) note's Propensity Score may be quickly determined by finding the specific category that the new property falls into and then assigning that Propensity Score to the new property's note.

Additionally, the model may continue to use present data to evolve to reflect current market conditions. For example, more recent historical data may be weighted more heavily in determining a Propensity Score for a unique category. Alternatively, data beyond a certain age may be discarded.

In some embodiments, the system filters out notes that contain extreme attributes. For example, a remaining term of one (1) year on an assumable note is not likely to be assumed. In similar such cases, the system excludes notes with certain extreme attribute values.

Returning to FIG. 4, in step 401, the system creates a root node for the tree that represents all of the basis assumptions contained in the basis table and the full range of each of the basis attributes. In step 402 the system calculates the mean Propensity Contribution for the node from all of the Propensity Contributions for the notes contained in that node.

FIG. 6 is a tree diagram showing a root node corresponding to the basis table 500. The root node 601 represents the assumptions having identifiers 2, 8, 9, 11, 13, and 14; values for the type attribute with values of “VA”, “FHA”, and term with a range of “1” to “360”.

FIG. 4A illustrates a flowchart 400 of a recursive function that loops through each node of the tree, including the root node created in step 401 to determine if it is possible to “split” the node, for example, to, create two children of the node each representing a different sub range, perhaps quantized as described above, of an attribute value range represented by the node. These steps generally identify a potential split opportunity having the highest information gain, and determine whether the information gain of that potential split opportunity exceeds the information gain of the current node as further described below with regard to FIG. 7.

In step 403, the system determines whether the node's population—that is, the number of basis assumptions represented by the node—satisfies a split threshold, such as a split threshold that requires more than three basis assumption opportunities. If the threshold is not satisfied, then the system exits at step 404 without identifying any split opportunity, such that the system will not split the node; otherwise, the system continues in step 405. Though not shown, the system may apply a variety of other tests to determine whether the node may be split, including whether any of the selected attribute ranges represented by the node is divisible. For example, where the selected attributes are type and term, and a node represents the ranges type=FHA and term=340, none of the node's selected attribute ranges can be split.

In step 402, the system determines the mean Propensity Contribution among the assumption opportunities represented by the node to obtain mean Propensity Contribution for the node. Applying step 402 to root node 601 shown in FIG. 6, the system determines a mean Propensity Contribution for the node as shown below in Table 1.

TABLE 1

| | | |
|---|---|---|
| 1 | Node mean Propensity | 333 |
| | Contribution = | |

In steps 405-409, the system analyzes the characteristics of each possible split opportunity that exists in the node; that is, for each attribute range represented by the node, any quantized point at which that range may be divided. For root node 601, we have quantized Term into 60 month groupings and created the following split opportunities: (1) type=VA and type=FHA; (2) term<=240 months and term>240 months; (3) term<=300 months and term>300 months. In step 407, for each side of the possible split opportunity, the system determines the mean Propensity Contribution among assumption opportunities on that side to obtain a split side mean Propensity Contribution. Table 4 below shows the performance of this calculation for both sides of each of the three possible split opportunities of root node 601.

TABLE 2

| | | |
|---|---|---|
| 1 | Split side mean propensity of | 0 |
| | type = VA side of split opportunity | |
| | 1 = mean of Propensity | |
| | Contribution for notes 2, 11 = | |
| 2 | Split side mean Propensity | 500 |
| | Contribution of type = FHA side of | |
| | split opportunity 1 = mean of | |
| | Propensity Contribution for notes | |
| | 8, 9, 13, 14 = | |
| 3 | Split side mean Propensity | 0 |
| | Contribution of term <= 240 side | |
| | of split opportunity 2 = mean of | |
| | Propensity Contribution for notes | |
| | 2, 8 = | |
| 4 | Split side mean Propensity | 500 |
| | Contribution of term > 240 side of | |
| | split opportunity 2 = mean of | |
| | Propensity Contribution for notes | |
| | 9, 11, 13, 240 = | |
| 5 | Split side mean Propensity | 250 |
| | Contribution of term <= 300 side | |
| | of split opportunity 3 = mean of | |
| | Propensity Contribution for notes | |
| | 2, 8, 9, 13 = | |
| 6 | Split side mean Propensity | 500 |
| | Contribution of term > 300 side of | |
| | split opportunity 3 = mean of | |
| | Propensity Contribution for notes | |
| | 11, 14 = | |

The flowchart then continues in FIG. 4B. In step 408, the system sums the squares of the differences between the mean Propensity Contribution of the node and each split side mean Propensity Contribution to obtain a possible split opportunity squared discernment factor. The result of the calculation of step 408 for root node 601 is shown below in table 3.

TABLE 3

| | | |
|---|---|---|
| 7 | Possible split opportunity 1 | 111 |
| | squared discernment factor for | |
| | notes 2, 11 = (333 − line 1)\hat{ }2 | |
| 8 | Possible split opportunity 1 | 28 |
| | squared discernment factor for | |
| | notes 8, 9, 13, 14 = (333 − line | |
| | 2)\hat{ }2 | |
| 9 | Possible split opportunity 1 | 139 |
| | squared discernment factor = sum | |
| | of lines 7-8 | |
| 10 | Possible split opportunity 2 | 111 |
| | squared discernment factor for | |
| | notes 2, 8 = (333 − line 3)\hat{ }2 | |
| 11 | Possible split opportunity 2 | 28 |
| | squared discernment factor for | |
| | notes 9, 11, 13, 14 = (333 − line | |
| | 4)\hat{ }2 | |
| 12 | Possible split opportunity 2 | 139 |
| | squared discernment factor = sum | |
| | of lines 10-11 | |
| 13 | Possible split opportunity 3 | 7 |
| | squared discernment factor for | |
| | notes 2, 8, 9, 13 = (333 − line 5)\hat{ }2 | |
| 14 | Possible split opportunity 3 | 28 |
| | squared discernment factor for | |
| | notes 11, 14 = (333 − line 6)\hat{ }2 | |
| 15 | Possible split opportunity 3 | 35 |
| | squared discernment factor = sum | |
| | of lines 13-14 | |

In step 409, if another possible split opportunity remains to be processed, then the system continues in step 405 to process the next possible split opportunity, else the system continues in step 410.

If none of the discernment factors are greater than zero (as further described below in FIG. 7), then the system exits in step 411. In step 412, the system selects the possible split opportunity having the greatest discernment factor. In the example, the system compares lines 9, 12 and 15 to identify the possible split opportunity 12 as having the greatest discernment factor (line 9 has a discernment factor equal to line 12 and may be chosen). In steps 413 and 414 the system creates a pair of children for the node by recursively initiating the steps in FIG. 4 twice, once for each child. Each child represents one of the sub ranges of the split opportunity identified in step 412 and the node's full range of unselected (remaining) attributes. Each child represents all basis assumptions whose attributes satisfy the attribute ranges represented by the child.

FIG. 7 is a tree diagram 700 showing a completed version of the sample tree. It may be seen that the system added child nodes 702 and 703 to root node 601 through two new calls to FIG. 4 each corresponding to the sub ranges defined by the split opportunity selected in step 412. Node 702 represents assumptions whose term attribute is less than or equal to 240, as well as the full range of type attribute values represented by node 601. Accordingly, node 702 represents assumptions 2 and 8. The Propensity Score of node 702 is calculated by determining the mean assumption contribution of assumptions 2 and 8 (0+0)/2 (i.e. 0). Because this number of assumptions is below the threshold of 3, for example, node 702 qualifies as a leaf node and the system exits at step 404. Node 703 represents assumptions with term attribute values greater than 240, i.e., 241-360. Node 703 further represents the full range of type attributes values for node 601. Accordingly, node 703 represents sales 9, 11, 13, and 14. Because this number of assumptions is not smaller than the threshold number and the node's ranges are not indivisible, the system proceeded to consider possible split opportunities. In order to do so, the system performs the calculation shown below in Table 4.

TABLE 4

| | | |
|---|---|---|
| 16 | node mean note Propensity | 500 |
| | Contribution = mean of note | |
| | Propensity Contribution for notes | |
| | 9, 11, 13, 14 | |
| 17 | split side mean Propensity | 0 |
| | Contribution of type = VA side of | |
| | possible split opportunity 4 = | |
| | mean Propensity Contribution of | |
| | note 11 | |
| 18 | split side mean Propensity | 667 |
| | Contribution of type = FHA side of | |
| | possible split opportunity 4 = | |
| | mean Propensity Contribution of | |
| | notes 9, 13, 14 | |
| 19 | split side mean Propensity | 500 |
| | Contribution of term <= 300 side | |
| | of possible split opportunity 5 = | |
| | mean Propensity Contribution of | |
| | notes 9, 13 | |
| 20 | split side mean Propensity | 500 |
| | Contribution of term > 300 side of | |
| | possible split opportunity 5 = | |
| | mean Propensity Contribution of | |
| | notes 11, 14 | |
| 21 | possible split opportunity 4 | 250 |
| | squared discernment factor for | |
| | note 11 = (500 − line 17)\hat{ }2 = | |
| 22 | possible split opportunity 4 | 28 |
| | squared discernment factor for | |
| | notes 9, 13, 14 = (500 − line 18)\hat{ }2 = | |
| 23 | sum of lines 21-22 | 278 |
| 24 | possible split opportunity 5 | 0 |
| | squared discernment factor for | |
| | notes 9, 13 = (500 − line 19)\hat{ }2 = | |
| 25 | possible split opportunity 5 | 0 |
| | squared discernment factor for | |
| | notes 11, 14 = (500 − line 20)\hat{ }2 = | |
| 26 | sum of lines 24-25 | 0 |
| | variance for possible split | |
| 27 | opportunity 4 = line 23/2 | 69 |
| 28 | variance for possible split | 0 |
| | opportunity 5 = line 26/2 | |

From Table 4, it may be seen that, between split opportunities 4 and 5, split opportunity 4 has the greater variance, shown on line 27. It may further be seen that the variance of possible split opportunity 4 shown on line 27 is greater than zero. Accordingly, the system uses possible split opportunity 4 to split node 703, creating child nodes 704 and 705. Child node 704 represents basis assumption 11, and that attribute ranges term=241-360; type=VA; and a mean Propensity Contribution of 0. Node 705 represents basis of sales 9, 13, and 14, and attribute value ranges term=241-360 and type=FHA. Node 705 has a mean Propensity Contribution of 667 obtained by averaging the Propensity Contribution for sales 9, 13, and 14 (i.e. (0+1000+1000)/3=667).

In order to apply the completed tree 700 shown in FIG. 7 to obtain its valuation for a particular assumable note, the system retrieves that note's attributes. As an example, consider an assumable note having attribute values term=340 and type=FHA. The system begins at root node 601, and among edges 711 and 712, traverses the one whose condition is satisfied by the attributes of the note. In the example, because the value of the term attribute for the home is greater than 240, the system traverses edge 712 to node 703. In order to proceed from node 703, the system determines, among edges 713 and 714, which edge's condition is satisfied. Because the note's value of the type attribute is FHA, the system traverses edge 714 to leaf node 705, and obtains a Propensity Score for the sample note of 667.

Those skilled in the art will appreciate that the tree shown in FIG. 7 may not be representative in all respects of trees constructed by the system. For example, such trees may have a larger number of nodes, and/or a larger depth. Also, though not shown in this tree, a single attribute may be split multiple times, for example, in multiple levels of the tree.

FIG. 8 shows a flowchart 800 of the steps typically performed by the system in order to score a tree. In step 801, the system identifies recent assumptions within the selection set (for example, a specific mortgage portfolio) that were not used as a basis for constructing the tree in order to score the tree. In step 802 the system calculates the mean propensity contribution for all transactions in 801. In steps 803-807, the system loops through each sale identified in step 801. In step 804 the system squares the difference between each leaf's Propensity Score and mean Propensity Contribution from 802. In step 805 the system weights each leaf by multiplying 804 by the number of transactions in the leaf. In step 806 the system sums the weights for all leaves. In step 808 the result from step 806 is divided by one less than the number of assumption opportunities in 801 to yield the tree's discernment factor or score. After step 807, these steps conclude.

When a note is valued using the forest, each tree is preferably applied to the attributes of the note. (If any attributes of the note are missing, the system typically imputes a value for the missing attribute based upon the median or mode for that attribute in the recent assumption opportunities table.) The Propensity Score produced will be the weighted average of each tree in the forest. Each tree's weight will be that trees score (discernment factor) divided by the summation of all the trees' scores.

It will be appreciated by those skilled in the art that the above-described system may be straightforwardly adapted or extended in a various ways. For example, the system may use a variety of user interfaces to collect various information usable in determining attributes for notes and notes from users and those individuals knowledgeable about assumable mortgages. Additionally, the system may use service bureaus and market data providers to supply interest rate data, public database data, geographic data, direct endorsement underwriting attributes, insurance data, for example. While the foregoing description makes reference to particular embodiments, the scope of the invention is defined solely by the claims that follow and the elements recited therein.

Displaying Propensity Score and User Valuation

The system typically displays the Propensity Score and User Valuation for a subject note in response to an expression of interest by the user to see such a display.

FIG. 10 is a flow diagram 1000 showing steps typically performed by the system in order to retrieve and process user queries for Propensity Scoring and determination of specific user values based upon assumption. The interactions described in FIG. 10 and elsewhere are typically performed by serving web pages to a user with knowledge of or interest in the subject mortgage, and receiving input from that user based upon the user's interaction with the web pages. These web pages may be part of a web site relating to aspects of residential real estate. FIGS. 14-20, and 23-26, described in greater detail below, contain sample displays presented by the system in some embodiments in performing the steps of FIG. 10.

In step 1001 the user logs into the system and is authenticated. Users that have visited the system before have stored profiles. From the user's profile the system recognizes the user's type as either Buyer, Seller, Agent, MSR Investor, or Guest. In some embodiments the system may allow users to make queries without authentication and in that case the system will apply Guest to the user's type.

In step 1002, the system selects the Display Template that matches the user's type and retrieves it from the Assumable Mortgage Database.

FIG. 14 illustrates seller valuation system query interface 1400. The query interface 1400 includes an address entry field 1401, a search button 1402, and a re-calculate button 1403. As further described below, a user may enter a property address into the address entry field 1401 and initiate a search for a property at that address by activating the search button 1402. If a property is found at that address in the database, then the property information may be displayed for the user on the interface. The property information may include the calculation date, assumable rate, monthly payment, unpaid principle balance, months remaining, home value, listed for sale, advertised as assumable, loan type, and market rate. FIG. 14 shows a sample display typically presented by the system to enable a user, in this case a seller, to begin an interactive query.

FIG. 15 illustrates an alternative geographic property selection interface 1500 for selection of a property, as further described herein. As shown in FIG. 15, a geographic area may be selected by the user and then a graphical interface including a map of the area may be displayed. The map includes an indication of each property for sale at its respective geographic position. As shown in FIG. 15, properties with an assumable mortgage that has a Propensity Score that has exceeded the Propensity Score Threshold may have a superimposed identified, such as the dollar sign. Alternatively, properties with an assumable mortgage that does not have a Propensity Score that has exceeded the Propensity Score Threshold may have no superimposed identifier, or may have an alternative superimposed identifier. FIG. 15 shows, for example, how a user might typically begin a query on the system initiated through a real estate listing website.

As one example, the user logs into the system and the system presents a blank query template such as display 1400 of FIG. 14 matching the Seller user type.

In step 1003 the system gets a query including loan details from the user. There are several methods for the user to submit queries. The user can enter the address of a home that has or that they suspect has an assumable mortgage into the input field 1401 and hit the Search button 1402 to initiate a query. Alternatively, the user may choose to view an assumable mortgage corresponding to a home that is for sale while they are browsing a real estate website such as the one in display 1500 of FIG. 15. For example, by selecting or double clicking marker 1501 they can initiate a query on the mortgage attached to the home represented by the marker.

In some embodiments, the system interacts with external systems from which it receives loan information requests and to which it responds with loan details, Propensity Score, and a User Valuation. In some embodiments, the system interacts with users in batch mode from which the system receives lists of loans with multiple information requests and to which the system responds with lists of loan details, Propensity Scores and User Valuations. Those skilled in the art would recognize that there are many other ways to interact with the system including many not described herein.

Returning to FIG. 10, if the loan is found in the Assumable Loan Database, all of its attributes are displayed and the system calculates and displays the Propensity Score and User Valuation for the subject note as in display 1600 of FIG. 16.

FIG. 16 is a display diagram showing a sample display typically presented by the system to satisfy an interactive query made by the user (home seller), and to allow the user to change attributes and initiate a new or refined query.

If the note is not found all attributes and output fields remain blank leaving only the information typed in by the user. In step 1005 the system takes all the loan attributes associated with the query and executes FIG. 11 to determine Propensity Score.

The system next determines which user valuation model to apply and which user values to display. In step 1006 if the user type is =Buyer, Seller, Agent, or Guest the system then calculates buyer's, seller's, and agent's benefits in FIG. 12. In step 1007, if the user type is =MSR Investor the system then calculates MSR investor's benefits in FIG. 21. In step 1008 the system displays all note attributes, the calculated Propensity Score, and the user values corresponding to the user type. In step 1009 the systems returns to 1003 to see if there is another query.

FIG. 12 is a flow diagram 1200 showing steps typically performed by the system to automatically determine the Projected Buyer's Benefit, the Projected Seller's Benefit and the Projected Agent's Benefit. In step 1201 the system receives the results (Monthly Interest Savings (MS), Life of Loan Savings (LOL), Mortgage Assumption Value (MAV)) from the calculation of Buyer's/Seller's maximum benefits as described in FIG. 13. Next, in step 1202 the system retrieves the Buyer's/Seller's Apportionment Model from the Assumable Loan Database. In step 1203 the system applies the Buyer's/Seller's Apportionment Model to the loan attributes to yield the Seller's Ratio. In one embodiment, the Buyer's/Seller's Apportionment model takes the mortgage assumption value and divided it by Propensity Score/1000 to determine the Seller's Ratio. In step 1204 the system calculates the Buyer's Ratio as 1 minus the Seller's Ratio from step 1203. In step 1205 the system calculates the Projected Buyer's Benefit as the product of the Buyer's Ratio from step 1204 and the Monthly Savings (MS) value from step 1201. In step 1206 the system calculates the Projected Seller's Benefit as the product of the Seller's Ratio from step 1203 and the Mortgage Assumption Value (MAV) value from step 1201. In step 1207, the system calculates the Projected Agent's Benefit as the product of the Projected Seller's Benefit from step 1206 and the Real Estate Commission Rate from the loan attributes. After step 1207 the system exits FIG. 12.

FIG. 13 is a flow diagram 1300 showing steps typically performed by the system to automatically determine the Buyer's/Seller's maximum benefits. This routine will calculate monthly interest savings (MS), life of loan savings (LOL) and Mortgage Assumption Value (MAV). In the first step, 1301, the system retrieves current market interest rate from the Assumable Loan Database. In step 1302 the system calculates the monthly interest savings (MS) by taking the difference between monthly amortization payments (principal and interest only) that are calculated using the remaining term of the assumable loan in months and the current unpaid principal balance of the assumable loan using the assumable loan rate and then again using the current market interest rate from step 1301, thus all values including term remaining and unpaid principal balance will preferably remain the same for the monthly payment calculations (principal and interest only) with the exception of the interest rate.

In step 1303, the system calculates the life of loan savings (LOL) as the product of the MS from step 1302 and the number of months remaining in the term of the assumable loan. Next, in step 1304 the system calculates the Mortgage Assumption Value (MAV) by discounting the MS cash flows by using a discount rate equal to the market interest rate from step 1301, for example MAV=MS*(1−v̂n)/i where v=1/(1+i) and i=the annual interest rate/12. In the final step 1305 the system returns the MS, the LOL and the MAV.

Tailoring Propensity Score and User Valuation to User Input

The system typically initiates the tailoring of Propensity Score and User Valuation for a subject note to input from a user in response to an expression of interest by the user in performing such tailoring.

FIG. 16 illustrates the seller valuation system query interface 1600 when a successful address entry has led to the population of the interface 1600 with information about the assumable mortgage to be found at the property. In various embodiments, the system enables the user to express such interest in a variety of ways. As one example, after the user has input modifications to attributes in display 1600 the user may select the Re-Calculate link 1605. Returning to FIG. 10, in step 1007 the system displays a refined Propensity Score and refined User Valuation that takes into account the attributes updated by the user. Step 1004 is executed when the user selects the Re-Calculate link 1605.

The user can interact with any of the fields displayed to change a corresponding attribute value. For example, the seller of a home can interact with control 1601 to determine what the effect of paying down his mortgage principal by the sum of $75,000. His current unpaid principal is displayed in 1601. The current loan to value ratio (LTV) is calculated by the system in 1602. In this example the system determines the current Propensity Score in 1603 and based upon the attributes provided to the system calculates a Projected Seller's Benefit before the action of paying down the mortgage in 1604. The seller next modifies attributes in FIG. 17.

FIG. 17 illustrates the seller valuation system query interface 1700 when the seller modifies attributes in the interface. FIG. 17 shows a sample display typically presented by the system to satisfy a user's (home seller) request to modify attributes and initiate a refined interactive query. More specifically, FIG. 17 shows the seller updating the Unpaid Principal Balance 1701 to represent making a $75,000 payment toward outstanding principal. In some embodiments, the system determines a new Propensity Score by applying the existing geographic-specific Propensity Scoring System, in other words the existing forest of trees, to the loan with updated attributes. The system preferably re-traverses all of the trees of the forest and returns a new Propensity Score. In some embodiments, the new Propensity Score feeds the User Valuation Model and a new User Valuation is displayed. New values are displayed when the user selects the Re-Calculate link 1605. The new loan to value ratio is calculated by the system in 1702. In this example the system determines the new, lower Propensity Score in 1703. Because the Propensity Score is lower the Projected Sellers Benefit in 1704 is also lower. The Seller can see that in this case paying down his principal will have a negative effect on his assumption benefit and utilize this result as a factor his decision making.

If the user makes a mistake or desires to return to the original Propensity Score and User Valuation, the user can select a link 1606 to restore the original data on which the initial Propensity Score and User Valuation were based.

The user can also change the display template. Although the system displays the default attributes that match the user's type, if these attributes are not the ones that the user desires to see or to input to, the user can modify the attributes displayed. The user selects Configure Fields link 1607 from the display 1600 to initiate a change to the output fields and attributes that are displayed on the screen.

FIG. 18 illustrates a configure links interface 1800. FIG. 18 shows a sample display typically presented by the system to enable a user (home seller) to begin to customize their user display and input screen, to add or delete attributes or output fields. Selecting the Configure Fields link 1607 brings up interface 1800 from which the user can add or remove fields or attributes. The user can choose to remove attributes be selecting the Remove link next to any existing attribute as shown in 1802. The user can add attributes by selecting the Add Fields link 1803 add fields. After selecting the Add Field link, a drop down box 1804 appears. The drop down box contains a set of the attributes currently available on the system. The user can scroll through the list of all available attributes. A list of some of the attributes included in the system appears in FIG. 9.

FIG. 9 is a list of possible attributes, or data elements, from which the trees or other data structures that determine propensity to assume can be constructed. This list is not exhaustive and new attributes can be added and old ones removed as time goes on. When the list of attributes changes, the system will itself determine how important the changes are for scoring the propensity of a note to be assumed. If new output fields or attributes are chosen they appear on the user's screen.

If the user makes a mistake or desires to return to the original set of output fields and attributes that correspond to the template matching their user type, the user can select link 1608 to restore the original through which the initial Propensity Score and User Valuation were displayed.

FIG. 19 illustrates a MSR valuation system interface 1900. FIG. 19 shows a sample display typically presented by the system to satisfy an interactive query made by the user, an MSR investor, and to allow the user to change attributes and initiate another query. In FIG. 19, a different type of user, a MSR Investor, tailoring attributes to achieve a particular result. In this example the user retrieves the Propensity Score and User Valuation for a specific note. The MSR Valuation 1906 shows $1,847, and the Propensity Score 1907 shows “325”. The user believes that if he can increase the Propensity Score the MSR Valuation will increase. The user notes that Seller Awareness attribute 1902 is unknown, meaning that the seller may not be aware of the value embedded in his or her mortgage. The user postulates that he could increase Propensity Score and MSR Valuation by including an insert in the mortgagors next billing cycle to inform the Mortgagor about the value imbedded in their mortgage if the mortgage was to be assumed. The result would enable the user to change the Seller Awareness attribute to “High.” The user does this and hits the Re-Calculate button.

FIG. 20 illustrates a modified MSP valuation system interface 2000. FIG. 20 shows a sample display typically presented by the system to satisfy a user's, the MSR investor's, request to modify attributes and initiate a refined interactive query. FIG. 20 shows the results of the change in attribute. The Propensity Score rose to “858” as can be seen in 2002. MSR Valuation increased to $2064 as can be seen in 2003. The MSR investor can compare the cost of including the insert to the increase in MSR Valuation to determine whether the measure is a cost effective approach towards increasing value. In other embodiments an MSR investor can perform the above calculations on an entire portfolio of loans.

FIG. 21 is a flow diagram 2100 showing steps typically performed by the system to automatically determine a Mortgage Servicing Right (MSR) value. In the first step 2101 the system sets the discount rate equal to the market interest rate if the user did not specify a discount rate in 1904, and sets n equal to the number of months remaining in the loan. Steps 2102-2108 are repeated for each month remaining in the loan. In step 2103 the system calculates the cash flow for each month as the product of the service fee rate, 1904, and the current unpaid principal balance, 1901, less one-twelfth of the expenses, 1905.

In step 2104 the discounted cash flow for the month is calculated as the product of the cash flow, as calculated above, and the discount factor (1+discount rate)̂−n/12 where the discount rate is user input, 1904. Then in step 2105 the system retrieves the Loan Survival Model from the Assumable Loan Database. In step 2106, the system applies the Loan Survival Model from 2105 to the note attributes to yield the loan survival factor. In step 2107 the system calculates the product of the discounted cash flow, 2104, and the loan survival factor from 2106. In step 2108 the system moves on to calculate discounted cash flow for the next period. Step 2109 yields the Propensity adjusted MSR value as the summation of all results from 2107.

FIG. 22 is a flow diagram 2200 showing steps typically performed by the system to automatically build the Loan Survival Model that will convert a Propensity Score into a loan survival factor. In step 2201 the system retrieves historical assumption data from the Mortgage Assumption Database. Next, in step 2202, the system builds a function using data from 2201 to relate loan survival probability to the Propensity Score. There are several factors, including the Propensity Score that affect the loan survival probability function. There are various commercially available (such as WinOAS from MIAC Analytics) and proprietary MSR valuation systems that can be adapted to utilize the Propensity Score to yield more accurate valuation results. For demonstration purposes we will accumulate all the factors together except the Propensity Score. Those skilled in the art will appreciate how the Propensity Score would be used alongside various other factors in an MSR valuation system. In one embodiment, as an example in order to isolate the effect of the Propensity Score on the loan survival function and therefore on the MSR valuation we set loan survival probability=0.85+0.00014×Propensity Score. Those skilled in the art will appreciate that there are other methods to incorporate the Propensity Score into the loan survival probability function. Most embodiments will include many factors in addition to the Propensity Score into the model. In the last step, 2203, the system stores the Loan Survival Model in the Assumable Mortgage Database.

Propensity Score Alerts

As another adaption, in some embodiments, where user input has caused the system to produce an updated Propensity Score or an updated User Valuation for a mortgage that varies from the original Propensity Score or original User Valuation by more than threshold percentage, the system displays a warning message indicating that the Propensity Score or User Valuation has changed significantly, and may not be accurate or may require a user action.

FIG. 23 illustrates a property alerts interface 2300. FIG. 23 shows a sample display typically presented by the system to enable a user to customize alerts based on assumption propensity and other factors. In FIG. 23, a user may configure Propensity Score Threshold alerts. Control 2304 allows the user to determine at what Propensity Score the alert will be triggered. Control 2301 allows the user to set a location around which alerts will be activated. Control 2303 establishes a Distance Threshold, or a distance from the anchor location input in 2301 where alerts will be triggered. Alternatively, instead of inputting a location the user can select the Get My Location control 2302 and the system will use the user's current location as the anchor location for alerts.

FIG. 24 illustrates a mobile property alerts interface 2400. FIG. 24 shows a sample display typically presented by the system to enable a user to customize alerts that include a Distance Threshold from the user's current location. This shows how a user can set alert thresholds on their mobile device and when they physically change location a new set of alerts will be generated.

FIG. 25 illustrates a mobile alerts property distance interface 2500. This shows how the alerts that include a Distance Threshold from the user's current location can be displayed on a map.

FIG. 26 illustrates a mobile property alerts results interface 2600. This shows how the alerts that include a Distance Threshold from the user's current location can be displayed in a list of properties that includes the distance from the user's current location.

In some embodiments the alert is delivered to the user in the form of an email message containing details on a property or set of properties that have either a high Propensity Score or a high user valuation. In other embodiments the alert is delivered in the form of an electronic message delivered to the user's telephone or mobile device. In still other embodiments the alert is delivered to a map application displaying real properties for sale and the alert allows the map to color or otherwise distinguish an identifier for the property differently than it would for a property that is for sale but does not have an assumable mortgage that exceeds the Propensity Score Threshold or the User Value Threshold. This is shown in display 1500 where the marker for a home with an assumable mortgage that has not exceeded the threshold is colored light blue and has a small house structure on it 1501, while the home that has a mortgage where the Propensity Score threshold has exceeded has a green color and a dollar sign “$” image on it 1502. Those skilled in the art would recognize that there are other potential delivery methods for such alerts.

In some embodiments the alert can be combined with a Distance Threshold and a Reference Location, such as where the user is currently located at a point in time, or a location near where a Buyer desires to live, or an area that a Realtor considers their sales territory. The system will generate alerts when there are homes for sale that have exceeded either the Propensity Score Threshold or the User Value Threshold and are within the Distance Threshold from the Reference Location. Each time the user establishes or changes the reference location the system will generate a new set of alerts if the attributes cause Propensity Score Threshold or the User Value Threshold to be exceeded. For example, if the user was using their current location as the Reference Location and they drove their car into a new neighborhood the system would automatically generate a new set of alerts corresponding to the Propensity Score Threshold or the User Value Threshold and the Distance Threshold and the new Reference Location.

Administration

FIG. 27 is a flow diagram 2700 showing steps typically performed in order to administer the system. The system allows users to select one of a number of options 2701. The options include Build Propensity Scoring System 2702, Build Buyer/Seller Apportionment Model 2703, Build Loan Survival Model 2704, Build Other User Models 2705, Perform other administrative tasks 2706. The activation of the administrative activities described above is shown as an option selected by a user, but those skilled in the art would recognize that any of these administrative activities could also be initiated by batch, be event driven, or initiated in a number of other ways.

FIG. 28 is a flow diagram 2800 showing steps typically performed by the system to build a Buyer's/Seller's Valuation Model. In step 2801 the system retrieves historical assumption data from the Mortgage Assumption Database. In step 2802, the system builds a function to determine the Seller Ratio from a Propensity Score. In some embodiments, linear regression may be used to build this function using the historical data from step 2801. Those skilled in the art will appreciate that other methods, such as support vector machines, artificial neural network, and other regression techniques, may be used to fit a function to the data. In the final step 2803, the system stores the Buyer/Seller apportionment function in the Assumable Mortgage Database.

FIG. 29 is a flow diagram 2900 showing steps typically performed by the system to perform Data Transformation on historical records. For all historical records the systems records the Propensity Score 2902, calculates the Buyer's/Sellerss maximum benefits 2903, gets comparable sales information 2904, determines the seller's actual benefit from the assumption 2905, determines what the portion of their benefit over the sales price is 2906, and stores all results for future use 2907.

Other Adaptions

As another adaption, in some embodiments, the system generates a tailored Propensity Scoring System that is constrained to use a certain subset of available attributes. In some embodiments this involves using a model of another type that is constructed using only the subset of attributes, such as a regression model constructed by plotting each of the appropriate vectors and using fitting techniques to construct a function yielding a Propensity Score whose independent variables are the values of the attributes among the subset. This function is then used to determine the Propensity Score of the subject mortgage.

Those skilled in the art will appreciate that there are other techniques that may be used to determine Propensity Score. In some embodiments, support vector machines, artificial neural networks, uplift modeling and various regression models (such as linear, logistic, K NN Kernel, multivariate adaptive regression splines, etc.) as well as many other techniques may be used in place of or in addition to the random forest of trees technique as described herein.

One or more embodiments of the present invention provide one or more of the following: a method in a computing system for automatically determining a valuation of an assumable note (or mortgage being a specific type of note) in response to input from an owner, servicer, or other stakeholder, or input from exogenous databases, (market) data feeds, whether input manually or electronically (either manually or automatically); method in a computing system for automatically determining a propensity of an assumable note (or mortgage being a specific type of note) to be assumed in response to input from an owner, servicer, or other stakeholder, or input from external databases, (market) data feeds, whether input manually or electronically (either manually or automatically).

Additionally, propensity as used herein may alternatively be referred to as tendency, inclination, partiality, proclivity, predisposition, likelihood, susceptibility, and predilection.

Additionally, one or more aspects of the present invention provide one or more of the following: presenting a display that includes indications of the note valuation and/or propensity for the subject note and indications of attributes and/or parameters used in determining such valuation and propensity to be assumed; presenting a display that solicits input from users/stakeholders that updates one or more indicated attributes/parameters; presenting a display to the users/stakeholders updates of one or more indicated attributes/parameters, which have been updated or input from electronic means (either manually or automatically); updating from input from all sources the valuation and propensity in an automated fashion and displaying such updates; presenting a display that solicits input from the user/stakeholder to update attributes/parameters including but not limited to the original terms and conditions of the note; using the inputs to display valuation and/or propensity of assumption based on the density of other notes in a geographic area; based on density of notes vs. any other parameter/attribute.

Further, one or more embodiments of the present invention include a non-transitory computer-readable storage medium with an executable program stored thereon, wherein the program instructs a microprocessor to perform the method of procuring information about a distinguished note from its owner or other stakeholder that is usable to refine an automatic valuation of the distinguished note the method comprising: displaying at least a portion of the information about the distinguished note used in the automatic valuation of the note or its propensity to be assumed; obtaining user input from a stakeholder adjusting at least one of the parameters/attributes used in the automatic valuation of the note or its propensity to be assumed; and displaying a refined valuation or propensity to assume that is based on the adjustment of the obtained user input.

Also, one or more embodiments of the present invention provide for: warning the user when input data is not useful in the automatic valuation of the note or its propensity to be assumed; warning the user when the refined valuation of the note or its propensity to be assumed diverges by more than a threshold percentage; the ability for a user to add an attribute/parameter that is not considered in the automatic valuation or propensity to assume but that once described is incorporated into an a prior calculation for the note valuation or the propensity to assume; the adjustment of the obtained user or electronic input includes identifying recent assumptions of other like notes to the distinguished notes wherein the displayed refined valuation or propensity is based at least in part on a repetition of the automatic valuation or propensity of the distinguished note in which the influence of the identified assumptions is magnified, wherein the adjustment of the obtained input (user or electronic) further includes identifying a scoring of the notes assumed in the identified assumptions reflecting the relative level of similarity of the assumed notes to the distinguished notes, and wherein the displayed refined valuation is based at least in part on a repetition of the automatic valuation of the distinguished note in which the influence of the identified assumption is magnified in a manner consistent with the identified scores.

One or more embodiments of the present invention also include: displaying a map showing notes in a geographic region surrounding the distinguished note; displaying a table comprising rows each containing textual information about a different one of a plurality of recent assumptions of notes within a geographic region, wherein the adjustment of the obtain input (user or electronic) includes identifying by the user/stakeholder notes regarded by the user/stakeholder as similar to the distinguished note.

Also, one or more embodiments of the present invention provide a computing system for: refining an automated valuation or automated note propensity of assumption of a distinguished note based on input; presenting the refined valuation or propensity to user/stakeholder (as source of input); and presenting the refined valuation or propensity to user/stakeholder other than the user/stakeholder of the sourced input.

Additionally, in one or more embodiments, the parametrically-based note valuation or propensity is a forest of classification trees each constructed from information about recent assumptions of notes parametrically linked to the distinguished note.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An assumable mortgage valuation system, said system including:
a buyer valuation system receiving an identification of a property having a target assumable mortgage, wherein said buyer valuation system determines a mortgage assumption value based on at least the unpaid principal balance, interest rate, remaining term of the assumable mortgage, and the difference between the mortgage rate of the assumable mortgage and the present mortgage interest rate; and
a computerized interface displaying said mortgage assumption value and one or more of said unpaid principal balance, remaining term of the assumable mortgage, mortgage rate of the assumable mortgage, and the present mortgage interest rate,
wherein said computerized interface allows one or more of said displayed unpaid principal balance, remaining term of the assumable mortgage, mortgage rate of the assumable mortgage, and the present mortgage interest rate to be altered by a user,
wherein said computerized interface interacts with said buyer valuation system to determine a revised mortgage assumption value and displays said revised mortgage assumption value to said user.

2. The assumable mortgage valuation system of claim 1 wherein said mortgage assumption value is expressed in terms of net present value.

3. The assumable mortgage valuation system of claim 1 wherein said computerized interface displays a map showing the location of said property.

4. The assumable mortgage valuation system of claim 1 wherein buyer valuation system receives a home valuation representing the value of said property.

5. The assumable mortgage valuation system of claim 4 wherein said computerized interface displays said home value.

6. The assumable mortgage valuation system of claim 4 wherein said computerized interface displays the loan to value ratio representing the unpaid principal balance divided by said home value.

7. The assumable mortgage valuation system of claim 4 wherein said computerized interface displays a monthly interest savings representing a dollar amount a buyer would save each month based on the mortgage rate of the assumable mortgage as compared to the present mortgage interest rate.

8. The assumable mortgage valuation system of claim 7 wherein computerized interface displays a projected buyer's life of loan benefit based on said monthly interest savings times the number of months in said remaining term of said assumable mortgage.

9. A non-transitory computer-readable storage medium with an executable program stored thereon, wherein the program instructs a microprocessor to perform the following steps:
receiving, at a computer system, an identification of a property having a target assumable mortgage;
determining a mortgage assumption value based on at least the unpaid principal balance, interest rate, remaining term of the assumable mortgage, and the difference between the mortgage rate of the assumable mortgage and the present mortgage interest rate;
displaying, on a computerized interface, said mortgage assumption value and one or more of said unpaid principal balance, remaining term of the assumable mortgage, mortgage rate of the assumable mortgage, and the present mortgage interest rate;
allowing, on said computerized interface, one or more of said displayed unpaid principal balance, remaining term of the assumable mortgage, mortgage rate of the assumable mortgage, and the present mortgage interest rate to be altered by a user;
determining a revised mortgage assumption value; and
displaying said revised mortgage assumption value to said user.

10. The non-transitory computer-readable storage medium of claim 9 wherein said mortgage assumption value is expressed in terms of net present value.

11. The non-transitory computer-readable storage medium of claim 9 wherein said computerized interface displays a map showing the location of said property.

12. The non-transitory computer-readable storage medium of claim 9 wherein said computerized interface receives a home valuation representing the value of said property.

13. The non-transitory computer-readable storage medium of claim 12 including displaying said home value.

14. The non-transitory computer-readable storage medium of claim 12 including displaying the loan to value ratio representing the unpaid principal balance divided by said home value.

15. The non-transitory computer-readable storage medium of claim 12 including displaying a monthly interest savings representing a dollar amount a buyer would save each month based on the mortgage rate of the assumable mortgage as compared to the present mortgage interest rate.

16. The non-transitory computer-readable storage medium of claim 15 including displaying a projected buyer's life of loan benefit based on said monthly interest savings times the number of months in said remaining term of said assumable mortgage.

17. A mortgage scoring system, said system including:
a propensity scoring system, wherein said propensity scoring system receives sale information including predetermined attributes with regard to a plurality of recent house purchases wherein said house purchases were financed using an assumable mortgage prior to said purchase, wherein said propensity scoring system uses said sale information to associate a propensity score with specific predetermined attributes of an assumable mortgage, wherein said propensity score represents the likelihood of an assumable mortgage loan to be transferred from a home seller to a home buyer when a property is sold; and
a computerized interface system receiving an identification of a target property having a target assumable mortgage, wherein said target assumable mortgage includes target assumable mortgage attributes, wherein said target assumable mortgage attributes are passed to said propensity scoring system and said target assumable mortgage attributes are used to determine a propensity score for said target assumable mortgage,
wherein said propensity score for said target assumable mortgage is displayed on said interface system.

18. The system of claim 9 wherein said propensity score is used to determine a purchase value for said assumable mortgage.

19. A method for identifying a propensity value associated with an assumable mortgage, said method including:
defining a plurality of mortgage categories, each category representing a unique quantized range of each of a plurality of mortgage variables;
associating a propensity value with each of said categories;
receiving an identification of an assumable mortgage, wherein said identification includes an identification of a mortgage-specific value for each of said plurality of mortgage variables;
classifying said assumable mortgage as belonging to one of said categories based on said plurality of mortgage-specific mortgage variables; and
identifying said propensity value for said category as a propensity value for said assumable mortgage.

20. The method of claim 19 wherein said mortgage variables include remaining term of mortgage and interest rate.
